(19) United States
(12) Patent Application Publication
(10) Pub. No.: US 2022/0381521 A1
(43) Pub. Date: Dec. 1, 2022

(54) ADDITIVELY MANUFACTURED POROUS HEAT EXCHANGER

(71) Applicant: Siemens Energy, Inc., Orlando, FL (US)

(72) Inventors: Michael A. Heminger, Rock Hill, SC (US); Jeffrey Gibson, Charlotte, NC (US); Landon Tully, Charlotte, NC (US); Christoph Kiener, Munchen (DE)

(21) Appl. No.: 17/332,419

(22) Filed: May 27, 2021

(51) Int. Cl. F28D 21/00; B33Y 80/00; F28F 21/04; F28F 21/08; F28D 9/00

(52) U.S. Cl. CPC F28D 21/0001; B33Y 80/00; F28F 21/04; F28F 21/083; F28F 21/087; F28D 9/0037; F28D 2021/0026

(57) ABSTRACT

A porous heat exchanger including a single piece core extending axially is provided. The core defines a first air inlet and a first air outlet for a first fluid, a second air inlet and a second air outlet for a second fluid. The first/second fluid flows into the core from the first/second air inlet through a first/second fluid channel and flows out of the core through the first/second air outlet. The core includes solid material sheets and porous material sheets disposed alternately with the solid material sheets so each porous material sheet has an adjacent solid material sheet on each side defining one of the first fluid channel for a flow of the first fluid or the second fluid channel for a flow of the second fluid. Heat transfer occurs between the first fluid in the first fluid channel and the second fluid in the second fluid channel.

### FIELD

The disclosure relates to heat exchangers, in general, and more particularly, to a recuperator employing an additively manufactured porous metal.

### BACKGROUND

Transferring energy or heat from one fluid stream to another is something common to a variety of industries. A heat exchanger is used for transferring heat between fluids. A recuperator is a type of heat exchanger that is usually fitted in the exhaust hot gases of a gas turbine engine to pre-heat compressed air prior to entry into the combustor to reduce fuel consumption and increase efficiency.

### BRIEF SUMMARY

In a first aspect, a porous heat exchanger includes a core comprising a single piece component extending axially. The core defines a first air inlet for a first fluid, a first air outlet for the first fluid, a second air inlet for a second fluid, and a second air outlet for the second fluid flow. The first fluid flows into the core from the first air inlet through a first fluid channel and flows out of the core through the first air outlet, and the second fluid flows into the core from the second air inlet through a second fluid channel and flows out of the core through the second air outlet. The core also includes a plurality of solid material sheets having a length that extends in the axial direction, and a plurality of porous material sheets having a length that extends in the axial direction, the porous material sheets disposed alternately with the plurality of solid material sheets so each porous material sheet has an adjacent solid material sheet on each side defining one of the first fluid channel for a flow of the first fluid or the second fluid channel for a flow of the second fluid. Heat transfer occurs between the first fluid in the first fluid channel and the second fluid in the second fluid channel.

In a second aspect, a modular additively manufactured porous heat exchanger includes a plurality of additively manufactured porous heat exchangers arranged so that an outlet of a first heat exchanger is in fluid communication with the inlet of a second heat exchanger.

In a third aspect, a porous heat exchanger includes a plurality of flow channels stacked in a stackwise direction to define a heat exchanger core. Each flow channel includes a first sheet, a porous flow layer formed as one-piece with the first sheet, a second sheet formed as one-piece with the porous flow layer, the second sheet also forming the first sheet of an adjacent flow channel, a hot flow path inlet and a hot flow path outlet each in fluid communication with a first portion of the plurality of flow channels, and a cold flow path inlet and a cold flow path outlet each in fluid communication with each cannel of the plurality of flow channels that are not part of the first portion of the plurality of flow channels.

In a fourth aspect, a method of producing a heat exchanger includes forming a plurality of flow channels by a forming a plurality of flow channels by a 3D printer employing a continuous additive manufacturing process in one-piece. The flow channels are stacked in a stackwise direction. The 3D printer settings are adjusted to create an open-cell porous structure, each flow channel including a first sheet, a porous flow layer formed as one-piece with the first sheet, a second sheet formed as one-piece with the porous flow layer, the second sheet also forming the first sheet of an adjacent flow channel, a hot flow path inlet and a hot flow path outlet each in fluid communication with a first portion of the plurality of flow channels, and a cold flow path inlet and a cold flow path outlet each in fluid communication with each channel of the plurality of flow channels that are not part of the first portion of the plurality of flow channels.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a perspective view of a micro gas turbine.

FIG. 2 illustrates a perspective view of an embodiment of a heat exchanger.

FIG. 3 illustrates a longitudinal cross-sectional view of an embodiment of a counter flow heat exchanger.

FIG. 4 illustrates a cross-sectional view of the counter flow heat exchanger of FIG. 3.

FIG. 5 illustrates a perspective view of an embodiment of a mixed flow heat exchanger.

FIG. 6 illustrates a top view of the embodiment of the mixed flow heat exchanger of FIG. 5.

FIG. 7 illustrates a chart showing the porosities of several porous metal samples.

FIG. 8 illustrates perspective view of an embodiment of a unit cell lattice structure.

### DETAILED DESCRIPTION

Micro Gas Turbines are small combustion gas turbines with power outputs ranging from approximately 30 kW to over 200 kW. These gas turbines are generally inefficient. A recuperator may be used to boost the efficiency of these machines by utilizing some of the waste heat from the gas turbine to pre-heat air before it enters the compressor.

In general, effective heat transfer requires maximizing surface area per unit of volume as heat exchanged is directly proportional to a total surface area of the heat exchanger. Typical recuperators employ thin, wavy corrugated fin sheets to increase surface area. Another concept to increase surface area in a recuperator is to use open pore metal foams.

Both of these solutions present significant challenges and limitations. Manufacturing such metal foams or fins places significant limitations on the possible design or layout of the recuperator. Additionally, the area augmenting feature, whether it be a metal foam or fin, must be in perfect contact with the flow channels to avoid decreases in performance. This requires a number of high precision weld or braze joints. Any failure of these braze or weld joints results in the decreased thermal efficiency along with the possibility of leaks.

Porous materials may be used in heat exchangers to increase surface area. Metal foams having a certain amount of porosity have been previously used in heat exchanger technology. The metal foams are generally created by injecting gas into a still-molten metal liquid. As the metal cools, the voids are left resulting in a foam. However, metal foams present many challenges. One such problem is creating metal foams of consistent quality with defined parameters.

With the advent of additive manufacturing, the ability to print porous metals is being developed. The issues described above using metal foams may be remedied by employing additive manufacturing to create uniform porous metals with predictable porosities that can be tuned to suit the application. The present inventors recognize that by utilizing additive manufacturing the porous surfaces of the heat exchanger may be printed integral with the solid flow channels.

Additive Manufacturing of components includes a wide range of materials and process techniques such as powder bed methods. Powder bed methods include selective laser melting (SLM), Selective Laser Sintering, and electron beam melting which use a laser as the power source to fuse the powdered material by aiming the laser automatically at points in space defined by a 3D model, binding the material together to create a solid structure. Binder jetting is another AM process in which a printhead selectively deposits a liquid binding agent onto a layer of powdered material to fuse the material together, creating the solid structure.

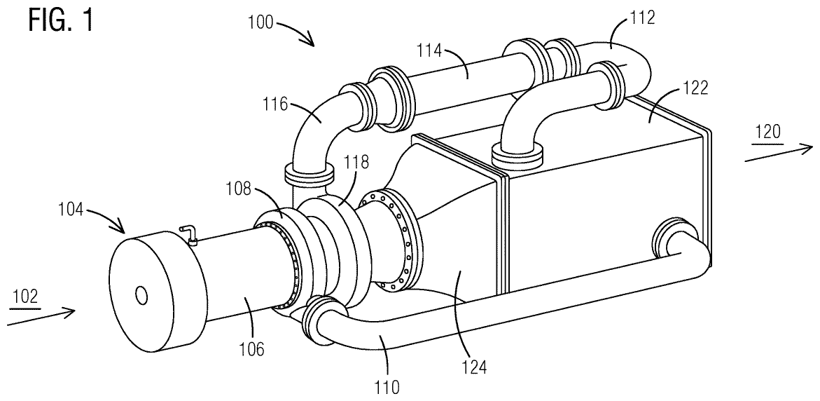

FIG. 1 illustrates an example of a micro gas turbine 100 having a generator 106, a compressor 108, a turbine 118, a combustor 114, and a recuperator 122. The compressor 108 is connected via a shaft to the generator 106 on one side and the turbine 118 on the other side. An exhausted gas 120 from the turbine 118 may be used by the recuperator 122 to pre-heat a compressed air flow before the air flow enters the combustor 114.

Starting on the left side of FIG. 1, air flow 102 enters the micro gas turbine 100 as shown by the arrow on the left side of FIG. 1, flows through a filter 104, into the generator 106, and on to the compressor 108 where the air is compressed. A portion of compressed air exits the compressor 108 through a compressed air line 110 which enters the recuperator 122 as a cooled air flow at an inlet. Within the recuperator 122, heat is transferred from the exhausted gas 120 to the compressed air and a pre-heated air flow exits the recuperator 122 at an outlet into a pre-heated air line 112. The pre-heated air enters the combustor 114 where a combustion of a fuel and the pre-heated air occurs. A hot gas exits the combustor 114 and flows through the turbine air line 116 into the turbine 118 wherein an expansion of the hot gas occurs. The exhausted gas 120 from the turbine 118 flows into the recuperator 122 from an inlet manifold 124, where the exhausted gas 120 is utilized by the recuperator 122 for heat transfer. A portion of the exhausted gas 120 flows out of the recuperator 122 and into an outlet manifold (not shown) where it may be utilized for another purpose.

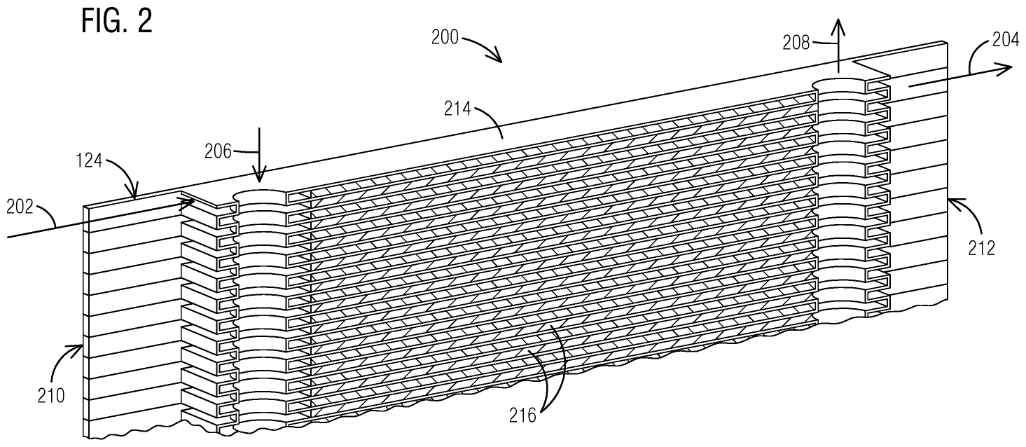

FIG. 2 illustrates an embodiment of a heat exchanger 200. In the embodiment shown in FIG. 2, the heat exchanger 200 is a co-flow heat exchanger, but other types of heat exchangers may be provided. For example, a counter flow heat exchanger or a heat exchanger having counter flow and co-flow sections may also be provided. The heat exchanger 200 includes a housing (not shown), similar to the housing seen on the recuperator 122 in FIG. 1, and transfers heat between at least two fluids.

The heat exchanger 200 comprises a core that is a single piece. The single-piece component includes both solid and porous portions. Additive manufacturing methods may be employed to produce the single piece component. The core extends axially having a first end 210 and a second end 212 that defines a fluid passageway, the fluid passageway extending between the first end 210 and the second end 212 on an interior of the core. A fluid flows from the first end 210 through the fluid passageway to the second end 212 or from the second end 212 through the fluid passageway to the first end 210. The fluid may comprise a flow of air of varying temperatures. However, in some embodiments, the fluid may also be a liquid.

The heat exchanger 200 includes a plurality of material sheets stacked in a stackwise direction of that define a plurality of flow channels. The stacked material sheets are formed as one piece so that one single contiguous component is produced. The plurality of material sheets alternate between a solid sheet 214 and a porous flow layer 216. Thus, the porous flow layer 216 has an adjacent solid sheet 214 on both sides so that a flow channel is created. A fluid may flow into the flow channel through an inlet, flow through the flow channel created within the porous flow layer 216, and flow out through an outlet.

As shown in FIG. 2, the heat exchanger 200 includes a first inlet 202 and a second inlet 206 and a first outlet 204 and a second outlet 208, respectively. A hot first fluid may flow into the first inlet 202, through its respective the flow channel where the hot first fluid is cooled down by a cold second fluid flowing into the second inlet 206 and through an adjacent flow channel. The cooled down first fluid flows out of the first outlet 204 and the warmed up second fluid flows out of the second outlet 208. Heat is transferred between the first fluid and the second fluid via conduction through the solid sheets 214 separating the first fluid and the second fluid. In an embodiment, the heat exchanger 200 may be utilized as the recuperator 122 in FIG. 1.

As stated above, the heat exchanger 200, shown in FIG. 2, is a co-flow heat exchanger 200 such that the hot first fluid and the cold second fluid flow in the same direction, but other types of heat exchangers may be provided without departing from the scope of the proposed heat exchanger.

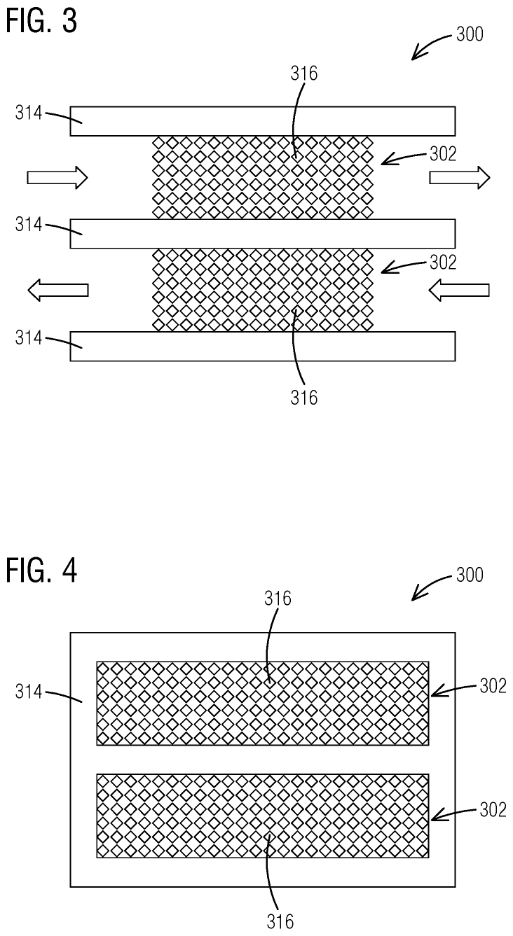

For example, FIG. 3 illustrates a longitudinal cross-section of a counter-flow heat exchanger 300 such that the hot first fluid flow and the cold second fluid flow flow in opposite directions. Counter flow heat exchangers are more efficient than co-flow heat exchangers, however, due to mechanical issues the allowable hot-side temperatures are reduced. Co-flow heat exchangers permit higher operating temperatures, however, they are less efficient.

FIG. 4 illustrates a cross-sectional view of the heat exchanger 300 shown in FIG. 3. From this view, it may be seen that the heat exchanger 300 includes a rectangular cross section, however, other cross-sectional shapes such as cylindrical may be used as well.

The heat exchanger 300 of FIGS. 3 and 4 includes two flow channels 302, however, the heat exchanger 300 may include two or more flow channels 302 stacked in a stackwise direction to form the core of the heat exchanger 300. Each flow channel 302 is defined by a first solid sheet 314, a second solid sheet 314, and a porous flow layer 316 positioned between the first solid sheet 314 and the second solid sheet 314. The first and second solid sheets 314 may include a solid, impermeable metal such as a nickel-based alloy and a stainless steel. A thickness of each solid sheet 314 may be in a range including 0.5 mm to 2.0 mm. The flow channels 302 may include linear profile, as seen in the longitudinal cross section shown in FIGS. 2 and 3. However, in a further embodiment, the flow channels 302 may include a wavy or sinusoidal profile which enhances the heat transfer between the fluid flows in the adjacent flow channels 302.

A porous material, as defined for the purposes of this disclosure, includes an open-cell pore structure such that there are no enclosed pockets within the material. Thus, the open-cell pore structure of the porous flow layer 216, 316 allows a fluid flow to pass uninterrupted through the porous material from the first end 210 to the second end 212. The porous flow layer 316 as shown in FIG. 3, lies in between the first and second solid sheets 314. This porous flow layer 316 allows a fluid flow (shown by the arrows) to pass through the flow channel 302. In an embodiment, the thickness of the porous flow layer 216, 316 is in a range of 5 to 25 mm. The thickness of the porous flow layer 216, 316 may vary depending on whether it carries the hot fluid flow or the cold fluid flow. For example, because the hot fluid stream is lower density, it usually includes a higher volumetric flow so the thickness of the porous flow layer 216, 316 may be thicker than the porous flow layer 216, 316 of the cold fluid stream.

In an embodiment, the porous material comprises a metallic material such as a nickel-based alloy or a stainless steel. In a further embodiment, the porous flow layer 216, 316 may include a ceramic material, such as silicon carbide. While ceramic materials are poor heat conductors, an advantage of utilizing ceramic materials in the heat exchanger 200, 300 as compared to metallic materials is that the overall weight of the heat exchanger 200, 300 would be much less than a heat exchanger that comprises only a metallic metal. As a heat exchanger, such as the recuperator 212 in FIG. 1, is typically a heavier component in a micro gas turbine 100, reducing its weight may be an important design consideration for particular applications. In an embodiment, for example, the overall weight of a ceramic heat exchanger 200, 300 including a ceramic porous flow layer 216, 216 is a third of that of a metallic heat exchanger 200, 300 including a porous flow layer 216, 316 comprising a metallic material such as a nickel-based metal as described above. In addition, a ceramic heat exchanger including a ceramic porous flow layer 216 would greatly increase inlet temperature of the fluid flow.

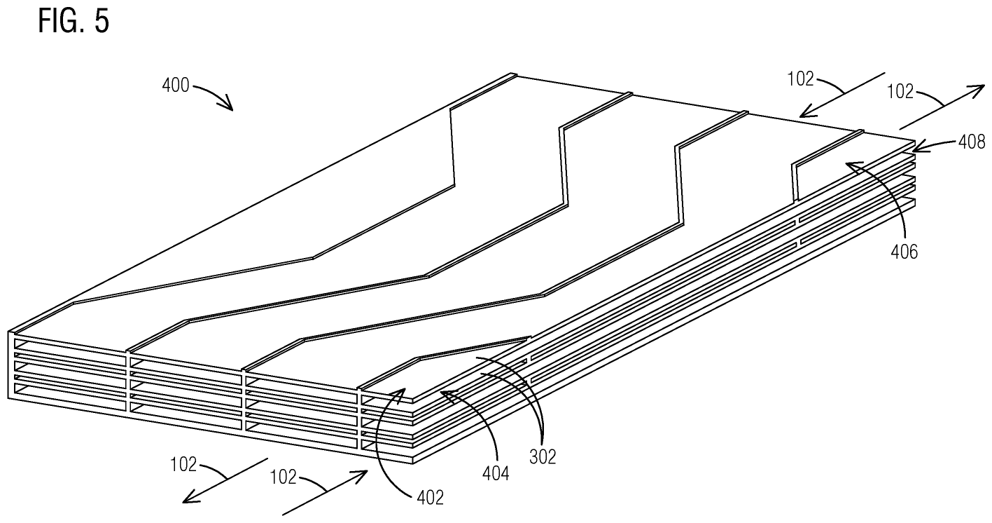

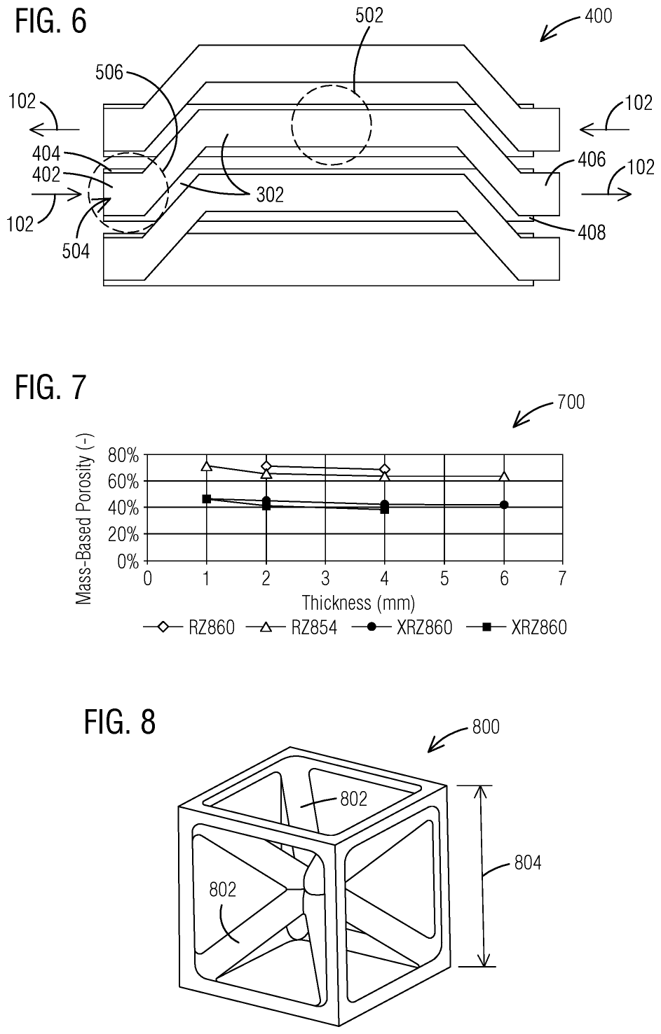

In an embodiment, as shown in FIGS. 5 and 6, a mixed flow heat exchanger 400 may include a plurality of flow channels 302 that are arranged so that the heat exchanger 400 includes a first section in which the flow channels 302 are arranged in a co-flow arrangement 506 and a second section in which the flow channels 302 are arranged in a counter flow arrangement 502.

FIG. 5 illustrates a perspective view of the flow channels 302 of heat exchanger 4. The flow channels 302 are disposed within a housing (not shown) similar to that shown in FIG. 1. An air flow 102, shown by arrows, flows through the air passageway defined by the core of the heat exchanger 400. A first flow channel 302 carries a first fluid from the first inlet 402 where it enters the core to the first outlet 406 where it exits the core of the heat exchanger 400. A second flow channel 302 carries a second fluid from the second inlet 404 where it enters the core to the second outlet 408 where it exits the core.

FIG. 6 illustrates a top view of the mixed flow heat exchanger 400 shown in FIG. 5. From this view, a plurality of flow channels 302 may be seen, a first air flow 102 entering the first inlet 402 and a second air flow 102 entering the second inlet 404 and respectively flowing out of first outlet 406 and second outlet 408. The first air flow 102 may include a cold fluid flow while the second air flow 102 may include a hot fluid flow. At the point of entering the first inlet 402 and the second inlet 404, respectively, shown by the circle on the left, the first air flow 102 flowing within its respective flow channel 302 and the second air flow 102 flowing in its respective flow channel 302 are in a co-flow arrangement 506, i.e., both the first air flow 102 and the second air flow 102 flow in the same direction. It may be seen in FIG. 5 that the flow channel 302 carrying the first air flow 102 crosses over a different adjacent flow channel 302, in a flow direction, between the first inlet 402 and the second inlet 404 such that the fluid in the adjacent flow channel 302 is flowing in the opposite direction than the first air flow 102. Thus, in the location shown by the circle on the right of FIG. 5, a counter flow arrangement 502 exits. A mixed co-flow/counter flow heat exchanger 400 such as that shown in the embodiment of FIGS. 5 and 6 permits a heat transfer while preventing any of the solid sheets 214 or porous flow layer 216 from becoming extremely hot, such as, for example, at the inlets or the outlets of the flow channels 302.

In an embodiment, the heat exchanger 200, 300, 400 may be a modular heat exchanger such that it comprises a plurality of single piece heat exchangers 200, 300, 400 so that the outlet of a first heat exchanger is in fluid communication with the inlet of a second heat exchanger. One advantage to having a series of repeated heat exchanger sections is that if one section, or single piece heat exchanger fails, (i.e., an inlet section to a heat exchanger typically experiences a failure first due to the stress the material experiences having an extremely hot fluid entering the heat exchanger) only the section experiencing the failure can be removed and replaced.

Additive manufacturing of porous materials allows the creation of a uniform porous flow layer 216, 316. These porous materials have a more predictable porosity than that of metal foams, for example, and thus can be tuned to suit the application. The chart 700, shown in FIG. 7, illustrates porosity measurements for various porous metal material samples that have been printed. As shown, the metallic material samples above a 2 mm thickness are well-controlled and repeatable. In addition, from the chart 700, it may be seen that in an embodiment, the density of the porous flow layer 216, 316 is less than 60% than that of the density of the material that forms the porous layer.

In an embodiment, the porous flow layer 216, 316 comprises a plurality of additively manufactured layers, the layers comprising a plurality of adjacent unit cells wherein each unit cell includes a lattice structure so that the pores are in fluid communication with one another. An embodiment of a unit cell comprising a lattice structure may be seen in FIG. 8. Each unit cell of the unit cell lattice structure 800 may include a cell height 804 of between 3.4 mm to 6.5 mm. The unit cell lattice structure 800 shown in FIG. 8 includes an arrangement of truss structures 802. Each truss structure 802 may include a length of between 0.5 to 1.5 mm which extend from a corner of the unit cell and extend to an interior position within the unit cell lattice structure 800. While FIG. 8 illustrates one example of a lattice structure, other open pore unit cell structures are also possible.

A method of producing a porous heat exchanger is also presented. The method includes the steps of forming a plurality of flow channels by a 3D printer employing a continuous additive manufacturing process in one-piece, the flow channels stacked in a stackwise direction. Each of the flow channels may be arranged as previously described. In contrast to forming the porous flow layer 216, 316 of the flow channels 302 utilizing a unit cell porous structure as discussed above, the porous flow layer 216, 316 may be formed by adjusting the laser settings on the 3D printer to create a porous open-cell structure.

An additively manufactured heat exchanger enables the ability to create a uniform ultra-high surface area flow layer comprising a porous material. By decreasing porosity, surface area may be increased, improving heat transfer and the efficiency of the heat exchanger. A porous flow layer comprising a lattice structure forms a particularly large surface area. An embodiment of an additively manufactured porous heat exchanger comprises a ceramic material porous material. While ceramic materials decrease the heat transfer ability of the heat exchanger as compared to a metallic heat exchanger, the ceramic heat exchanger allows inlet temperatures to increase beyond what is possible now and provides a lower weight option.

What is claimed is:

1. A porous heat exchanger, comprising:
a core comprising a single piece component extending axially, the core defining:
a first air inlet for a first fluid;
a first air outlet for the first fluid;
a second air inlet for a second fluid;
a second air outlet for the second fluid flow,
wherein the first fluid flows into the core from the first air inlet through a first fluid channel and flows out of the core through the first air outlet, and
wherein the second fluid flows into the core from the second air inlet through a second fluid channel and flows out of the core through the second air outlet;
a plurality of solid material sheets having a length that extends in the axial direction; and
a plurality of porous material sheets having a length that extends in the axial direction, the porous material sheets disposed alternately with the plurality of solid material sheets so each porous material sheet has an adjacent solid material sheet on each side defining one of the first fluid channel for a flow of the first fluid or the second fluid channel for a flow of the second fluid,
wherein a heat transfer occurs between the first fluid in the first fluid channel and the second fluid in the second fluid channel.

2. The heat exchanger of claim 1, wherein the porous heat exchanger is a counter flow heat exchanger.

3. The heat exchanger of claim 1, wherein the porous heat exchanger is a cross flow heat exchanger.

4. The heat exchanger of claim 1, wherein the heat exchanger includes a section having the first fluid channel and the second fluid channel arranged in a cross-flow arrangement and a second section having the first fluid channel and the second fluid channel arranged in a counter flow arrangement.

5. The heat exchanger of claim 1, wherein each solid material sheet includes a thickness of 0.5 mm-2 mm.

6. The heat exchanger of claim 1, wherein the porous material includes an open-cell pore structure.

7. The heat exchanger of claim 7, wherein each porous material sheet includes a plurality of additively manufactured layers, each layer comprising a plurality of adjacent unit cells wherein each unit cell includes a lattice structure.

8. The heat exchanger of claim 1, wherein the porous material is a nickel-based alloy.

9. The heat exchanger of claim 1, wherein the porous material is a stainless steel.

10. The heat exchanger of claim 1, wherein the porous material is a ceramic material.

11. The heat exchanger of claim 9, wherein the ceramic material is silicon carbide.

12. The heat exchanger of claim 1, wherein each channel of the plurality of channels includes a linear profile in the axial direction.

13. The heat exchanger of claim 1, wherein each channel of the plurality of channels includes a wavy profile in the axial direction.

14. The heat exchanger of claim 1, wherein the heat exchanger is a recuperator for a gas turbine engine.

15. A modular additively manufactured porous heat exchanger, comprising:
a plurality of additively manufactured porous heat exchangers as claimed in claim 1 arranged so that an outlet of a first heat exchanger is in fluid communication with the inlet of a second heat exchanger.

16. A heat exchanger, comprising:
a plurality of flow channels stacked in a stackwise direction to define a heat exchanger core, each flow channel including:
a first sheet;
a porous flow layer formed as one-piece with the first sheet;
a second sheet formed as one-piece with the porous flow layer, the second sheet also forming the first sheet of an adjacent flow channel;
a hot flow path inlet and a hot flow path outlet each in fluid communication with a first portion of the plurality of flow channels; and
a cold flow path inlet and a cold flow path outlet each in fluid communication with each channel of the plurality of flow channels that are not part of the first portion of the plurality of flow channels.

17. The heat exchanger of claim 17, wherein each porous flow layer has a density that is in a range of 40-60 percent of the density of the material that forms the porous flow layer.

18. A method of producing a heat exchanger, comprising:
forming a plurality of flow channels by a 3D printer employing a continuous additive manufacturing process in one-piece, the flow channels stacked in a stackwise direction, the forming including adjusting the 3D printer settings to create an open-cell porous structure, each flow channel including:
a first sheet;
a porous flow layer formed as one-piece with the first sheet;
a second sheet formed as one-piece with the porous flow layer, the second sheet also forming the first sheet of an adjacent flow channel;
a hot flow path inlet and a hot flow path outlet each in fluid communication with a first portion of the plurality of flow channels; and
a cold flow path inlet and a cold flow path outlet each in fluid communication with each channel of the plurality of flow channels that are not part of the first portion of the plurality of flow channels.
